(19) United States
(12) Patent Application Publication
(10) Pub. No.: US 2025/0058372 A1
(43) Pub. Date: Feb. 20, 2025

(54) HANDHELD PULLING AND COMPRESSING DEVICE

(71) Applicant: TKR SPEZIALWERKZEUGE GMBH, Gevelsberg (DE)

(72) Inventors: Torsten KREISCHER, Wetter (DE); Thorsten WEYLAND, Herdecke (DE)

(21) Appl. No.: 18/714,054

(22) PCT Filed: Nov. 29, 2022
(86) PCT No.: PCT/EP2022/083644

§ 371 Date: May 28, 2024

(30) Foreign Application Priority Data
Nov. 29, 2021 (DE) 10 2021 131 294.9

(51) Int. Cl. B21J 15/10

(52) U.S. Cl. CPC B21J 15/105

(57) ABSTRACT

The invention relates to a hand-held pulling and compression device for driving inter-changeable pulling and pressing tools, with a drive unit having a battery-operated electric motor and a scew drive with a threaded spindle connected to the electric motor and mounted rotatably on a housing body and a threaded nut mounted rotatably on the threaded spindle and non-rotatably on the housing body via a bearing unit. In order to provide a hand-held pulling and compression device which is suitable for driving inter-changeable pulling and pressing tools, it is provided that the hand-held pulling and compression device has a coupling unit which is connected to a tool holder and is connected to the threaded nut in such a way that pulling and compressive forces resulting from the direction of rotation of the threaded spindle are transmitted to the coupling unit.

The invention relates to a hand-held pulling and compression device for driving inter-changeable pulling and pressing tools, with
a drive unit comprising a battery operated electric motor and
a screw drive with a threaded spindle connected to the electric motor and mounted rotatably on a housing body and a threaded nut mounted rotatably on the threaded spindle and non-rotatably on the housing body via a bearing unit.

Hand-held pulling devices, i.e. devices that can be used mobile by one person, such as hand-held riveting tools for setting blind rivet elements, such as blind rivets and blind rivet nuts, which have a drive unit with an electric motor-driven threaded spindle of a screw drive, are known from the prior art in a variety of embodiments. The screw drive converts a rotational movement of the electric motor into a linear movement of the pulling and pressing tool in a known manner. In the case of the setting operation of a blind rivet element, for example, a mandrel of the blind rivet element is moved axially.

In addition, there are also electric pressing devices which also use a screw drive to convert the rotational movement generated by an electric motor into a linear movement of the pressing tool, e.g. to carry out punching processes or to set punch rivets.

The rivet and pressing devices described above are used, for example, in vehicle work-shops when carrying out repair work on the bodywork of vehicles. Depending on the work to be carried out, however, it is necessary to have both a pulling device and a separate pressing device ready in order to be able to carry out all the necessary work. However, the need to provide at least two devices leads to increased tool costs, especially if the tools are battery operated rather than cable-connected.

On this basis, the invention is based on the object of providing a hand-held pulling and compression device which is suitable for driving interchangeable pulling and pressing tools.

The invention solves the object by a hand-held pulling and compression device with the features of claim 1. Advantageous further embodiments of the invention are given in the dependent claims.

The hand-held pulling and compression device according to the invention is characterized by a coupling unit connected to a tool holder, which is connected to the threaded nut in such a way that tensile and compressive forces resulting from the direction of rotation of the threaded spindle are transmitted to the coupling unit.

According to the invention, the hand-held pulling and compression device is connected via a coupling unit to a tool holder, which is designed to interchangeably accommodate different pulling and pressing tools required for the respective application. For example, when used as a compression device, the tool holder can be designed to hold a riveter, which is used in conjunction with a rivet clamp arranged on the compression device for setting rivets. When used as a pulling device, the tool holder can, for example, be provided with suitable clamping devices for a blind rivet shank or have other means for transmitting tensile forces. Alternatively or additionally, the tool holder can also be designed to hold corresponding pulling tools, whereby the pulling tools have, for example, clamping means by means of which the tensile forces can then be transmitted.

For its part, the coupling unit is also connected to the threaded nut in such a way that both tensile and compressive forces resulting from the direction of movement of the threaded spindle and the resulting linear adjustment of the threaded nut are reliably transmitted to the coupling unit.

The hand-held pulling and compression device according to the invention makes it possible, depending on the work to be carried out, for example in the context of its use in a vehicle workshop when carrying out bodywork, to arrange a tool required for the respective operation on the tool holder. The hand-held pulling and compression device allows both pulling and pressing work to be carried out, e.g. setting blind rivets or carrying out punching work. The linear adjustment of the selected tool required for the respective operation is reliably transmitted to the tool holder via the coupling unit, as, in accordance with the invention, the coupling unit transmits both tensile and compressive forces from the threaded nut to the respective tool. The hand-held pulling and compression device thus makes it possible to dispense with at least two separate devices for carrying out pulling and pressing work.

The design of the screw drive for converting the rotational movement of the electric motor into a linear movement of the threaded nut and thus of the pulling and pressing tool, which is in operative connection with the threaded nut, is basically freely selectable. The screw drive is preferably designed in such a way that a tensile or compressive force of 1-7 tons, preferably 2-6 tons, acts on the coupling unit and/or the tool holder. Preferably, the threaded spindle has an outer diameter of 10-30 mm, preferably 12-25 mm, particularly preferably 14-22 mm, which advantageously enables a particularly compact screw drive. For example, trapezoidal threaded spindles can be used, the thread pitch of which can usually be selected in the range of 2 to 10 mm according to the forces to be achieved.

According to a particularly advantageous embodiment of the invention, however, it is provided that the screw drive is designed as a ball screw drive or planetary screw drive. The use of such screw drives with balls or rollers as rolling elements is characterized by the fact that, in contrast to trapezoidal screw drives, in which surfaces rub against each other, they have a particularly high efficiency, which makes it possible to reduce the dimensioning of the electric motor in order to achieve the desired pulling forces or compression pressures, so that the hand-held pulling and compression device can be designed to be particularly compact. Typical thread pitches of ball screw drives or planetary screw drives are 5 to 10 mm. Preferably, the threaded spindle has a pitch of 2-8 mm, more preferably 3-7 mm, most preferably 4-6 mm.

The design of the hand-held pulling and compression device according to the invention provides for the tool holder to be operatively connected to the threaded nut in such a way that tensile and compressive forces resulting from the direction of rotation of the threaded spindle are transmitted to the tool holder. The design of the coupling unit with the threaded nut required for this is basically freely selectable.

According to a particularly advantageous embodiment of the invention, however, an adapter unit is provided for transmitting tensile and compressive forces from the threaded nut to the coupling unit. The adapter unit has a first and second connecting element, the first connecting element being operatively connected to a first end face of the threaded nut and the second connecting element being operatively connected to a second end face of the threaded nut and the coupling unit, wherein the end faces of the threaded nut are aligned essentially perpendicular to the longitudinal axis direction of the threaded spindle and thus to the adjustment direction of the threaded nut.

To secure the connecting elements in their position relative to the threaded nut, they are also connected to each other in the longitudinal axis direction of the threaded spindle, whereby they are preloaded in the direction of the threaded nut. The connection of the connecting elements to each other ensures mutual transmission of the forces acting on the connecting elements from the threaded nut depending on its adjustment direction. Due to the active connection of the second connecting element with the second end face of the threaded nut and the coupling unit, it is also ensured that the coupling unit is fixed relative to the second end face of the threaded nut.

Forces acting in the direction of the coupling unit due to a correspondingly directed adjustment of the threaded nut lead to compressive forces between the threaded nut and the coupling unit, which are transmitted to the tool holder via the coupling unit. If the threaded nut moves in the opposite direction, the compressive forces acting on the first connecting element and generated by the threaded nut are transmitted to the second connecting element and thus also to the coupling unit via the connection between the first connecting element and the second connecting element, so that tensile forces are transmitted to the tool holder via the coupling unit in a corresponding manner.

The use of an adapter unit in accordance with the advantageous further development of the invention described above ensures in a particularly reliable manner that both tensile and compressive forces are reliably transmitted from the threaded nut to the tool holder.

According to a particularly advantageous embodiment of the invention, it is provided that the first connecting element rests against the first end face of the threaded nut and the second connecting element rests against a free end surface of the coupling unit resting against the second end face of the threaded nut and the connecting elements are connected to one another via at least two, preferably four, pull rods.

According to this embodiment of the invention, the two connecting elements together with the pull rods connecting them and extending in the longitudinal axis direction of the threaded spindle form a cage-like body which encloses the threaded nut. Via the first connecting element resting against the first end face and the second connecting element resting against a free end surface of the coupling unit resting against the second end face, it is reliably ensured that tensile and compressive forces are transmitted from the threaded nut via the coupling unit to the tool holder.

In the case of compressive forces resulting from a movement of the threaded nut in the direction of the coupling unit, these are transmitted directly to the coupling unit due to the contact of the coupling unit with the second end face of the threaded nut. A movement of the threaded nut in the opposite direction to the coupling unit results in tensile forces, which result from a conversion of the compressive forces acting on the first connecting element, which are transmitted to the second connecting element via the pull rods. The second connecting element rests against the free end surface of the coupling unit facing away from the second end face of the threaded nut. The use of at least two, preferably four, pull rods, which are particularly preferably distributed evenly around the circumference of the threaded nut, ensures reliable conversion of the compressive forces acting on the first connecting element into tensile forces acting on the second connecting element and thus on the coupling unit.

The design of the coupling unit for connection to the tool holder is basically freely selectable. For example, the coupling unit and the tool holder can also be designed in one piece. According to a particularly advantageous embodiment, however, it is provided that the coupling unit is designed for detachable connection to the tool holder. This design of the coupling unit makes it possible to arrange adapted tool holders on the coupling unit depending on the work to be carried out. This allows the use of standardized pulling and pressing tools and increases the range of applications of the pulling and compression device in a complementary manner.

According to a further embodiment of the invention, it is provided that the coupling unit is connected to the threaded nut in a non-rotatable manner. This embodiment of the invention makes it possible to dispense with a possibly provided non-rotatable arrangement of the coupling unit on the housing body, as the coupling unit is subsequently also arranged non-rotatably on the housing body via the non-rotatable connection of the threaded nut to the housing body provided according to the invention. The bearing unit provided for the non-rotatable arrangement of the threaded nut can in principle be designed in any way. It is conceivable here, for example, that the bearing unit is formed by a feather key embedded in the threaded nut, which is mounted in a corresponding guide rail on the housing body.

According to a further embodiment of the invention, however, it is provided that the bearing unit is designed in such a way that the threaded nut and/or the coupling unit connected non-rotatably to the threaded nut is supported in a rolling manner on the housing body. According to this embodiment of the invention, the bearing unit has at least one rolling element via which the threaded nut is supported in a rolling manner relative to the housing body. This embodiment of the invention ensures increased efficiency, since losses due to friction are reduced. In addition, the use of an appropriately further developed bearing unit provides a particularly simple backlash-free mounting of the threaded nut, so that tensile and compressive forces are reliably transmitted.

The specific design of the bearing unit for the rolling support of the coupling unit on the housing body, whereby suitable rolling elements are usually used for this purpose, is in principle freely selectable. According to a particularly advantageous embodiment of the invention, however, it is provided that the bearing unit has
a bearing roller arranged rotatably on a bearing journal projecting radially from the threaded nut or the coupling unit and supported circumferentially on two opposite sections of the housing body, or
two bearing rollers, each arranged rotatably on a bearing journal projecting radially from the threaded nut or the coupling unit and each resting against one of two opposite sections of the housing body on the circumferential side

According to the above embodiment of the invention, the bearing unit has one or two bearing rollers which are rotatably arranged on bearing journals which project from the threaded nut or coupling unit perpendicular to the adjustment direction. If a single bearing roller is used, this is supported on the housing body by two sections arranged opposite one another, viewed perpendicularly to the adjustment direction of the threaded nut, whereby the bearing roller rolls on the opposite housing body sections when the threaded nut is adjusted along the longitudinal axis direction of the threaded spindle.

In the case of the advantageously provided use of two bearing rollers, the threaded nut or the coupling unit have two bearing journals projecting from the threaded nut or the coupling unit perpendicular to the adjustment direction of the threaded nut, on each of which a bearing roller is rotatably arranged. The two bearing rollers are each supported by an area on the housing body, with the support areas being arranged opposite each other on the housing body, viewed perpendicular to the adjustment direction of the threaded nut, so that reliable support is also achieved in this way when the threaded nut is adjusted, with the bearing rollers each rolling on the housing body.

The design of the housing body for supporting the bearing unit is basically freely selectable. According to a particularly advantageous embodiment of the invention, however, it is provided that the housing body has at least two, preferably four, guide rods extending parallel to the threaded spindle and operatively connected to the bearing unit. The guide rods, which are each connected at the end, for example, to a bearing seat, form a cage-like housing body on which the bearing unit is supported. This design of the housing body, in particular the use of four guide rods, which are evenly distributed around the circumference of the threaded spindle, offers the possibility of making the housing body particularly simple, compact and lightweight. If the bearing rollers are used, when one bearing roller is advantageously used, it is supported on two adjacent guide rods and when advantageously two bearing rollers are used, respectively one bearing roller is supported on one of the two guide rods arranged adjacent to each other.

According to an advantageous embodiment of the invention, it is provided that the bearing rollers have a running surface that embraces the guide rods in sections. According to a particularly advantageous embodiment of the invention, it is provided that the guide rods have a circular cross-section and the running surface of the bearing rollers has a corresponding circular arc-shaped contour.

This embodiment of the invention ensures a particularly reliable bearing of the threaded nut and/or coupling unit and their non-rotatable arrangement relative to the threaded spindle. Relative movements of the bearing unit directed transversely to the spindle axis are avoided in a particularly reliable manner by these designs of the bearing rollers and the guide rods.

By dimensioning the guide rods accordingly, it can be reliably ensured that the bearing unit is reliably guided on the guide rods when bearing rollers are advantageously used, whereby all forces transmitted in the circumferential direction from the threaded nut to the guide rods are absorbed. According to a particularly advantageous embodiment of the invention, it is provided that the bearing unit has a clamp body engaging around the guide rods which are in engagement with the bearing rollers.

According to this embodiment of the invention, a clamp body is provided which engages around the guide rods on the outside in the area opposite the bearing rollers. The clamp body thus provides additional protection against an increase in the distance between the guide rods in the area of the bearing unit, so that additional support, in particular-viewed in the longitudinal axis direction-in the middle area of the guide rods, can be dispensed with. The clamp body reliably prevents an increase in the distance between the guide rods due to the forces applied in the circumferential direction when the threaded spindle is adjusted via the threaded nut.

In principle, the rotational movement of the motor can be transmitted to the threaded spindle in any desired manner. According to an advantageous embodiment of the invention, it is provided that the drive unit has a gear connecting the electric motor and the threaded spindle. The use of a gear makes it possible to transmit high torques with low installation space and weight. The gears used include, for example, two- to three-stage planetary gears as well as cycloidal and spur gears, which offer the desired ratios. Preferably, the speed of the electric motor and/or the transmission ratio of the gear and/or the pitch of the threaded spindle are adjusted in such a way that the tool holder connected to the threaded nut via the coupling unit is adjusted during operation at a feed speed of 700-8000 mm/min, preferably 1300-5100 rpm, particularly preferably 1900-3800 rpm, most preferably 2750 rpm. Preferably, the gear has a ratio of 1:70 to 1:30, preferably 1:60 to 1:40, particularly preferably 1:55 to 1:45, most preferably 1:50. The speed of the electric motor is preferably 25000-30000 rpm, preferably 26000-29000 rpm, particularly preferably 27000-28000 rpm, most preferably 27500 rpm. In combination with preferably provided brushless motors, which are battery operated, an optimal coordination between electric motor gearbox, threaded spindle and the resulting force can be achieved. Furthermore, the drive unit, in particular the electric motor and/or the gear, are designed in such a way that a torque of 10-100 Nm, preferably 15-95 N/m, most preferably 15-25 N/m and/or 75-95 N/m acts on the threaded spindle.

In the simplest embodiment of the hand-held pulling and compression device according to the invention, the electric motor is operable in such a way that only the direction of rotation of the threaded spindle can be selected. According to a particularly advantageous embodiment of the invention, however, it is provided that the drive unit is connected to a control unit which is designed for
controlling of the pulling and pressing operations and/or
archiving of the pulling and pressing operations.

According to this design, the use of a control unit allows targeted control of the corresponding pulling and pressing operations. For example, the control unit can be used to set the intended tensile or compressive forces in a particularly simple manner so that the pulling and pressing operations can be carried out particularly reliably. The control unit can also be provided for archiving the pulling and pressing operations carried out so that the work carried out can be reliably logged.

According to a particularly advantageous further development of the invention, the control unit is connected to a sensor unit for monitoring the pulling and pressing operations. The sensor unit can be designed to monitor the adjustment travel, the pulling or pressing forces, the torque or the like, which is required for carrying out the work operations and their successful completion. According to a particularly advantageous embodiment of the invention, the control unit is provided with a display, which makes it particularly easy for the operating personnel to operate the hand-held pulling and compression device. Furthermore, this can also be connected to a central database via suitable wireless transmission means.

An embodiment of the invention is explained below with reference to the drawings. The drawings show in:

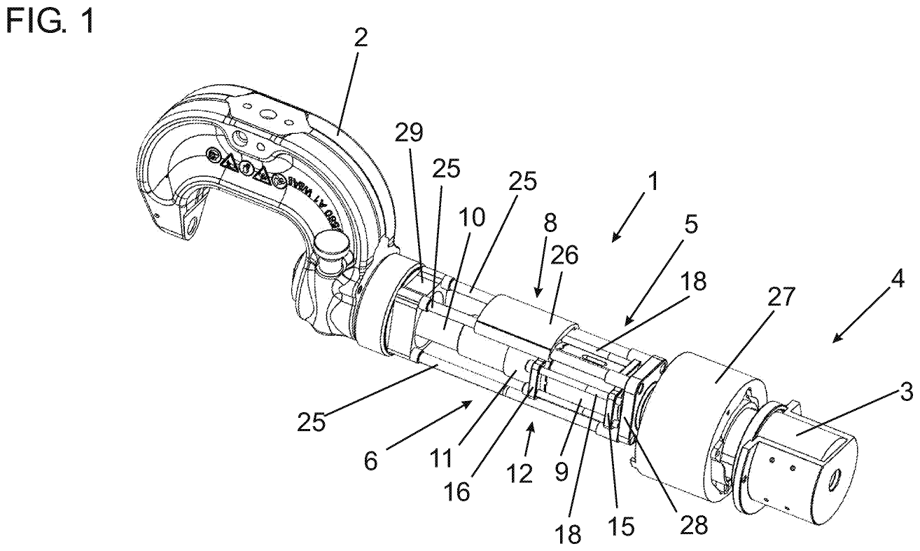

FIG. 1 a perspective view of a pulling and compression device with a connected rivet clamp;

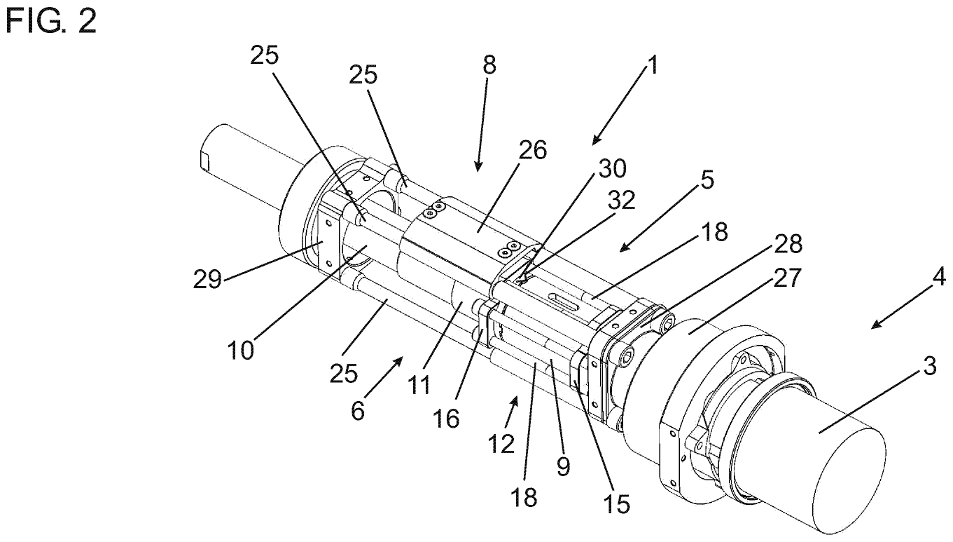

FIG. 2 a perspective view of the pulling and compression device of FIG. 1 without rivet clamp;

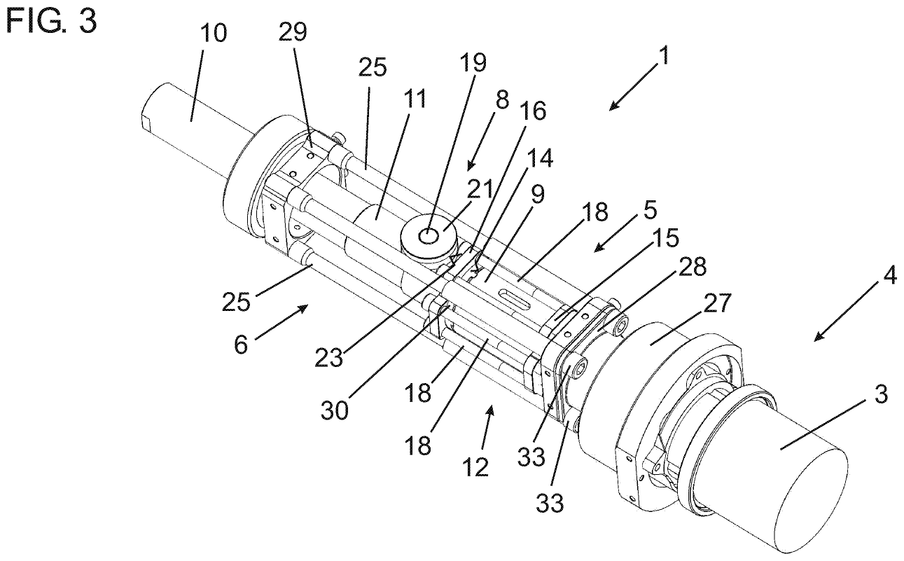

FIG. 3 a perspective view of the pulling and compression device of FIG. 2 without clamp body;

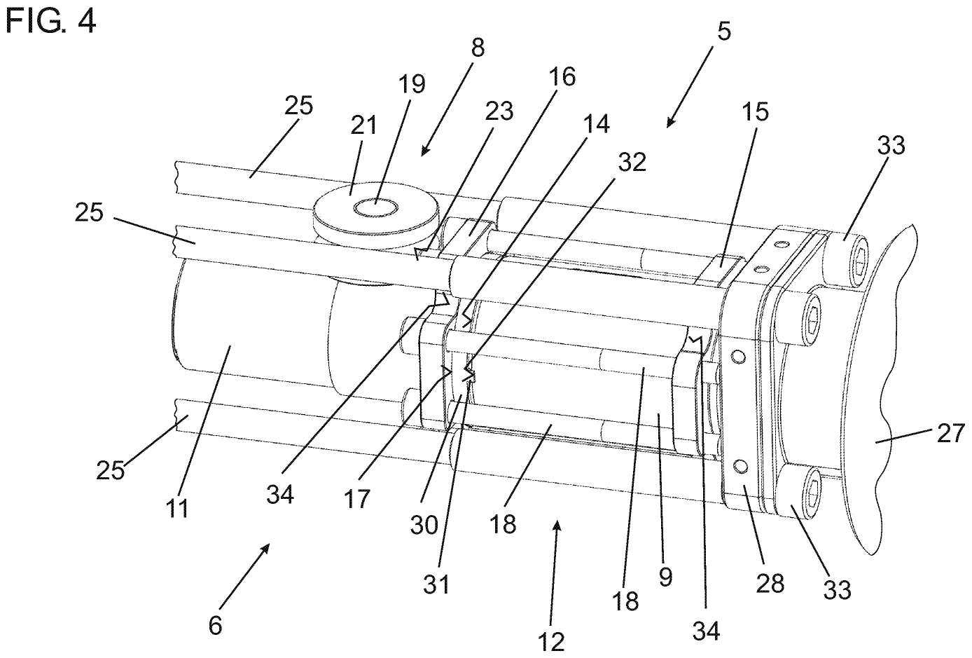

FIG. 4 an enlarged perspective view of the pulling and compression device of FIG. 3 in the area of a screw drive and

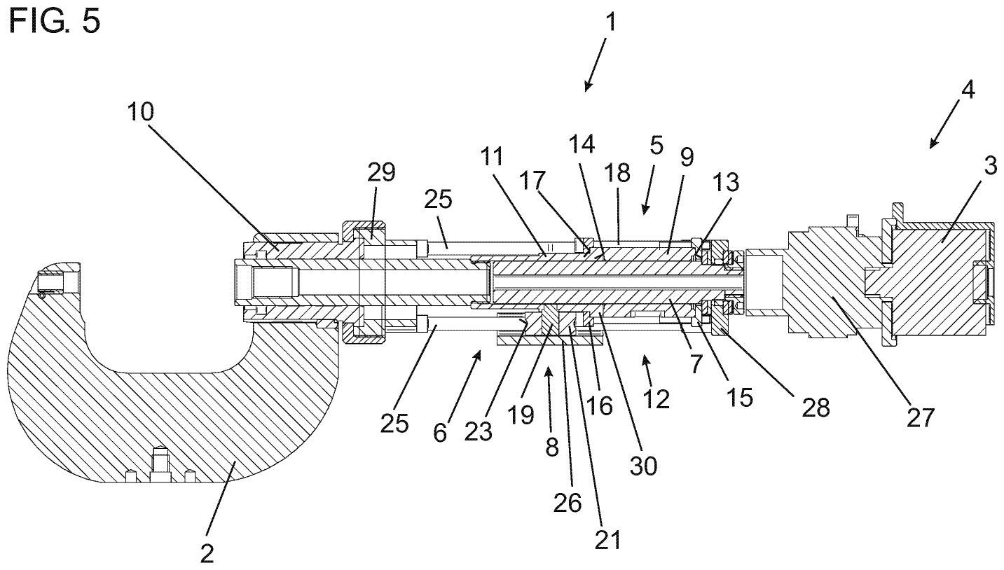

FIG. 5 a sectional view of the pulling and compression device of FIG. 1.

FIG. 1 shows a perspective view of a pulling and compression device 1 with a rivet clamp 2 arranged thereon. The pulling and compression device 1 has a drive unit 4 with an electric motor 3 and a gear 27 connected to the electric motor 3. By means of the electric motor 3, a threaded spindle 7 of a screw drive 5 connected to the gear 27 is driven via the gear 27, the threaded spindle 7 being rotatably mounted in a bearing seat 28 of a housing body 6 (see FIGS. 2 to 5).

In addition to the threaded spindle 7, the screw drive 5 also has a threaded nut 9 arranged on the threaded spindle 7, which is mounted non-rotatably on the housing body 6. The threaded nut 9 is used to drive a tool holder in the form of a piston rod 10, which is mounted in a bearing seat 29 so as to be adjustable in the longitudinal axis direction of the threaded spindle 7, so that punch riveting operations can be carried out by means of the pulling and compression device 1 via the connected rivet clamp 2.

The piston rod 10 is connected to the threaded nut 9 via a detachably connected coupling unit 11, which rests against a second end face 14 of the threaded nut 9 at its end opposite the piston rod 10. To prevent rotation of the coupling unit 11 relative to the threaded nut 9, the coupling unit 11 also has projections 31 on its contact surface with the second end face 14 of the threaded nut 9, which engage in cutouts 32 on the second end face 14 of the threaded nut 9.

An adapter unit 12 is used to transmit the linear movement generated by the threaded nut 9 to the coupling unit 11. This has a first connecting element 15 resting against the first end face 13 of the threaded nut 9 facing the gear 27 and a second connecting element 16 resting against a circumferential flange 30 of the coupling unit 11. The first and second connecting elements 15, 16 are connected to one another via pull rods 18 in the form of screws 18, which preload the connecting elements 15, 16 in the direction of the threaded nut 9, so that the adapter unit 12 encloses the threaded nut 9 in a cage-like manner.

Pressure movements, i.e. adjustment movements of the threaded nut 9 in the direction of the piston rod 10, are transmitted to the coupling unit 11 via the direct contact of the coupling unit 11 with the second end face 14 of the threaded nut 9. To generate tensile forces as a result of a displacement of the threaded nut 9 in the direction of the drive unit 4, the compressive forces acting on the first connecting element 15 resting against the first end face 13 of the threaded nut 9 are transmitted via the screws 18 to the second connecting element 16, which rests against the circumferential flange 30 of the coupling unit 11, so that the compressive forces are converted into tensile forces there.

A bearing unit 8, which is attached to the coupling unit 11, is used for the non-rotatable mounting of the threaded nut 9 on the housing body 6. The coupling unit 11 has a bearing journal 19 aligned perpendicular to the threaded spindle axis and projecting from the coupling unit 11, on which a bearing roller 21 is rotatably arranged. The bearing roller 21 is supported by two sections arranged adjacent to the threaded spindle axis on two parallel guide rods 25, so that the bearing roller 21 rolls on the guide rods 25 during an adjustment movement of the threaded nut 9 in the longitudinal axis direction of the threaded spindle 7. The running surface 23 of the bearing roller 21 is adapted to the contour of the guide rods 25, which are circular in cross-section. The total of four guide rods 25 extend parallel to each other and to the threaded spindle axis from the bearing seat 28 to the bearing seat 29 and form a stable housing body 6, on which the bearing unit 8 and thus the threaded nut 9 via the non-rotatable connection of the coupling unit 11 to the threaded nut 9 is supported on the housing body 6. The position of the bearing seats 28, 29 relative to one another is fixed by screws 33 fixing the guide rods 25. The guide rods 25 also run through recesses 34 on the connecting elements 15, 16, which allows a compact design of the pulling and compression device 1.

In order to prevent the guide rods 25 resting against the roller 21 from bending open, the bearing unit 8 also has a clamp body 26, which embrace the outside of the guide rods 25 in the area of the bearing unit 8 and ensures stable alignment of the guide rods 25 to one another.

In an embodiment example not shown here, the coupling unit 11 has two bearing journals 19 projecting from it in the area between two adjacent guide rods 25, on each of which a bearing roller 21 is arranged. The bearing rollers 21 are dimensioned in such a way that they each rest against only one of the two guide rods 25. Together, the two bearing rollers 21 thus support the coupling unit 11 on the two guide rods 25.

### LIST OF REFERENCE SYMBOLS

1 pulling and compression device
2 rivet clamp
3 electric motor
4 drive unit
5 screw drive
6 housing body
7 threaded spindle
8 bearing unit
9 threaded nut
10 tool holder (piston rod)
11 coupling unit
12 adapter unit
13 first end face (threaded nut)
14 second end face (threaded nut)
15 first connecting element (adapter unit)
16 second connecting element (adapter unit)
17 free end surface
18 pull rod (screw)
19 bearing journal
21 bearing roller (one roller)
23 running surface (one roll)
25 guide rod
26 clamp body
27 gear
28 bearing seat
29 bearing seat
30 flange (coupling unit)
31 projection
32 cutout
33 screw
34 recess

1. Hand-held pulling and compression device for driving interchangeable pulling and pressing tools, with
a drive unit comprising a battery operated electric motor and
a screw drive with a threaded spindle connected to the electric motor and mounted rotatably on a housing body and a threaded nut mounted rotatably on the threaded spindle and non-rotatably on the housing body via a bearing unit,
wherein
a coupling unit is connected to a tool holder, which is connected to the threaded nut in such a way that tensile and compressive forces resulting from the direction of rotation of the threaded spindle are transmitted to the coupling unit.

2. Hand-held pulling and compression device according to claim 1, wherein the screw drive is designed as a ball screw drive or planetary screw drive.

3. Hand-held pulling and compression device according to claim 1, wherein an adapter unit for transmitting tensile and compressive forces from the threaded nut to the coupling unit, having a first and a second connecting element which are operatively connected to a first end face of the threaded nut and to a second end face of the threaded nut and the coupling unit and which are connected to one another.

4. Hand-held pulling and compression device according to claim 1, wherein the first connecting element rests against the first end face and the second connecting element rests against a free end surface of the coupling unit resting against the second end face, and the connecting elements are connected to one another via at least two, preferably four, pulling rods.

5. Hand-held pulling and compression device according to claim 1, wherein the coupling unit is designed for detachable connection to the tool holder.

6. Hand-held pulling and compression device according to claim 1, wherein the coupling unit is connected non-rotatably to the threaded nut .

7. Hand-held pulling and compression device according to claim 1, wherein the bearing unit is designed in such a way that the threaded nut and/or the coupling unit connected non-rotatably to the threaded nut is supported on the housing body in a rolling manner.

8. Hand-held pulling and compression device according to claim 1, wherein the bearing unit has
a bearing roller arranged rotatably on a bearing journal projecting radially from the threaded nut or the coupling unit and supported circumferentially on two opposite sections of the housing body, or
two bearing rollers each arranged rotatably on a bearing journal projecting radially from the threaded nut or the coupling unit and each resting against the circumference of one of two opposite sections of the housing body.

9. Hand-held pulling compression and device according to claim 1, wherein the housing body has at least two, preferably four, guide rods which run parallel to the threaded spindle and are operatively connected to the bearing unit.

10. Hand-held pulling and compression device according to claim 1, wherein the bearing rollers have a running surface embracing in sections around the guide rods.

11. Hand-held pulling and compression device according to claim 1, wherein the guide rods have a circular cross-section and the running surface of the bearing rollers has a corresponding circular arc-shaped contour.

12. Hand-held pulling and compression device according to claim 1, wherein the bearing unit has a clamp body embracing the guide rods which are in engagement with the bearing rollers.

13. Hand-held pulling and compression device according to claim 1, wherein the drive unit has a gear connecting the electric motor and the threaded spindle.

14. Hand-held pulling and compression device according to claim 1, wherein the drive unit is connected to a control unit which is designed for
controlling of the pulling and pressing operations and/or
archiving of the pulling and pressing operations.

15. Hand-held pulling and compression device according to claim 1, wherein the control unit is connected to a sensor unit for monitoring the pulling and compression operations.
